(19) United States
(12) Patent Application Publication
(10) Pub. No.: US 2017/0141472 A1
(43) Pub. Date: May 18, 2017

(54) MILLIMETER WAVE ANTENNA FOR DIAGONAL RADIATION

(71) Applicant: Korea Advanced Institute of Science and Technology, Daejeon (KR)

(72) Inventors: Chul-Soon PARK, Daejeon (KR); Tae-Hwan JANG, Daejeon (KR); Hong-Yi KIM, Daejeon (KR); Chae-Jun LEE, Daejeon (KR)

(21) Appl. No.: 15/006,206

(22) Filed: Jan. 26, 2016

(30) Foreign Application Priority Data
Nov. 16, 2015 (KR) 10-2015-0160190

(51) Int. Cl. H01Q 9/04

(52) U.S. Cl. CPC H01Q 9/0414

(57) ABSTRACT

Disclosed is a millimeter wave antenna for diagonal radiation. A first metal layer and a second metal layer having a form of microstrip wire are coated on the bottom surface and at least a partial region of the top surface of a dielectric substrate, respectively. When viewed in a direction perpendicular to the top surface of the dielectric substrate, the second metal layer is covered by the first metal layer. The microstrip wire of the second metal layer may have a length of more than half of a wavelength of a RF signal. The long-wire antenna has a radiation pattern in upward diagonal direction when a signal to transmit is fed under a condition that the first metal layer is grounded. The form of the second metal layer may be a straight line, Y-shape, ψ-shape, or etc. An impedance matching metal layer may be added to the second metal layer.

### CROSS-REFERENCE TO RELATED APPLICATION

This application claims priority under 35 USC §119 to Korean Patent Application No. 10-2015-0160190, filed on Nov. 16, 2015 in the Korean Intellectual Property Office (KIPO), the contents of which are herein incorporated by reference in their entirety.

### BACKGROUND

1. Technical Field

The present invention relates to a long-wire antenna, and more particularly to a millimeter waveband antenna for radiating the millimeter wave in a diagonal direction.

2. Description of the Related Art

Recently, researches and developments on the Gbps-class wireless data transmission technologies using the millimeter wave, such as the Wireless Gigabit (WiGig), have been made actively. In particular, the technologies such as the millimeter wave high-speed data communication for the mobile communication terminals and the wireless communications that provide an interface for the inter-chip communication are in the spotlight. And thus, antennas for the millimeter wave communication are also drawing attentions.

A number of antennas for the millimeter wave communication have been released, and most of them are in general the antenna for the communication based on the horizontal and/or vertical radiation. For example, the antenna implemented on a planar substrate used for the mobile communication terminals is also designed for the radiation in the vertical or horizontal direction. However, to be practically used for the millimeter waveband, it is required for the antenna to have a capability of radiating the radio frequency (RF) wave in the diagonal direction for the transmission in several directions.

In the millimeter waveband communication, a high gain antenna with a narrow beam width is necessary. However, since the antenna designed for the vertical or horizontal radiation does not include a beam width component being diagonally-directional about the ground, the antenna that enables radiating in the diagonal direction is further needed. For example, a long-wire antenna has a large gain and a characteristic of radiating in the diagonal direction, thus being suitable for the applications in the millimeter waveband. However, lots of the long-wire antennas known so far are not suitable for the millimeter waveband communication because they are so large as to range in size from a few centimeters to several meters and thus have a difficulty in making a connection between the antenna and a communication chip. Therefore, for the various applications using the millimeter wave, it is required to develop the antenna that is not so large in size but can radiate in the diagonal direction, having a characteristic of a high gain at the same time.

### SUMMARY

The present invention has been made under the recognition of the above-mentioned problems of the conventional art. It is an object of the present invention to provide an antenna for the millimeter waveband having a good diagonal radiation characteristic.

It is another object of the present invention to provide an antenna for the millimeter waveband that has a good characteristic in the diagonal radiation as well as can be designed in a small size.

According to an embodiment of the present invention for achieving the above object, there is provided a long-wire antenna for millimeter wave radiation. The long-wire antenna may include a dielectric substrate, a first metal layer attached to or coated on at least a portion of a bottom surface of the dielectric substrate, and a second metal layer attached to or coated on at least a portion of a top surface of the dielectric substrate in a form of microstrip wire. The first and the second metal layers may be installed such that the second metal layer may be covered by the first metal layer when the first and the second metal layers are viewed in a direction perpendicular to the top surface of the dielectric substrate. The microstrip wire of the second metal layer may have a length equal to or greater than a half of a wavelength of a radio frequency (RF) signal to be transmitted. The long-wire antenna may have a RF signal radiation pattern in upward diagonal direction when a signal to be transmitted wirelessly is fed to the microstrip wire of the second metal layer when the first metal layer is grounded.

In an embodiment of the present invention, the second microstrip wire may be a straight line-shaped microstrip wire.

In another embodiment of the present invention, the second microstrip wire may be a Y-shaped microstrip wire including a first section (a stem section) that is a straight line shaped microstrip wire and a second section (a branch section) that is formed with two branches of the microstrip wire branched from an end of the straight line shaped microstrip wire. In an example of this embodiment, the first section and the second section of the Y-shaped microstrip wire may have substantially a same length.

In further another embodiment of the present invention, the second microstrip wire may be a ψ-shaped or a fork-shaped microstrip wire including a first section (the stem section) that is a straight line shaped microstrip wire and a second section (the branch section) that is formed with three or more branches of the microstrip wire branched from an end of the straight line shaped microstrip wire. In an example of this embodiment, the first section and the second section of the ψ-shaped microstrip wire or the fork-shaped microstrip wire may have substantially a same length

According to an embodiment of the present invention, the long-wire antenna may further include one or more grounded coplanar waveguide (GCPW) wires attached to or coated on the left top surface and the right top surface of the dielectric substrate about the second metal layer.

In an example of the embodiment, the GCPW wires may include a pair of ground metal pads coated on the left top surface and the right top surface of the dielectric substrate about the second metal layer. A pair of via-holes extended from each of the pair of ground metal pads to the first metal layer may be formed in the dielectric substrate. In addition, the GCPW wires may include a pair of connection wires for electrically connecting each of the pair of ground metal pads to the first metal layer through the via-holes.

According to an embodiment of the present invention, the long-wire antenna may further include an impedance matching metal layer, attached to or coated on the top surface of the dielectric substrate and connected to the second metal layer, for improving impedance matching of the antenna.

In an embodiment of the present invention, the second metal layer may be shorter than the first metal layer in a lengthy direction of the second metal layer such that a section of the second metal layer uncovered by the first metal layer can be secured.

In an embodiment of the present invention, a RF signal radiated from the second metal layer in a downward diagonal direction may be incident on and reflected by the first metal layer, propagating in an upward diagonal direction with a RF signal directly radiated from the second metal layer in the upward diagonal direction.

With the long-wire antenna implemented on the dielectric substrate according to the present invention, it is possible to obtain the diagonal radiation pattern. With the modified antenna structures, it is also possible to reduce height of the antenna. That is, the long-wire antenna according to the present invention has an advantage that it can be applied to various applications since it is designed such that it can be used for the millimeter waveband and has the radiation characteristic in the diagonal direction other than in the vertical or horizontal direction.

The antenna structure according to the present invention may be an antenna structure suitable for the mobile communication terminals and RF systems using the efficient millimeter band. In addition, the present invention may allow reducing the size of this type of antenna, and can meet the demands of miniaturization of antenna-using devices.

### BRIEF DESCRIPTION OF THE DRAWINGS

Illustrative, non-limiting example embodiments will be more clearly understood from the following detailed description taken in conjunction with the accompanying drawings.

FIG. 1 illustrates a transmission way using a horizontal radiation pattern from a mobile communication terminal to a high-performance display device.

FIG. 2 illustrates a transmission way using a vertical radiation pattern of a mobile communication terminal to a high-performance display device.

FIG. 3 illustrates a transmission way using a diagonal radiation pattern of a mobile communication terminal to a high-performance display device.

FIG. 4 illustrates a radiation pattern of a two-wire type long-wire antenna to explain the basic concept of the present invention.

FIG. 5 illustrates a front view of a straight line shaped long-wire antenna implemented as a microstrip wire on a substrate, according to a first embodiment of the present invention.

FIG. 6 illustrates a front view of a Y-shaped long-wire antenna implemented as a microstrip wire on a substrate, according to a second embodiment of the present invention.

FIG. 7 illustrates a front view of a ψ-shaped long-wire antenna implemented as a microstrip wire on a substrate, according to a third embodiment of the present invention.

FIG. 8 illustrates a side view of the antennas according to the first to third embodiments of the present invention shown in FIGS. 5-7.

FIG. 9 illustrates a front view of a straight line shaped long-wire antenna implemented as the GCPW wire on a substrate, according to a fourth embodiment of the present invention.

FIG. 10 illustrates a front view of a Y-shaped long-wire antenna implemented as the GCPW wire on a substrate, according to a fifth embodiment of the present invention.

FIG. 11 illustrates a front view of a ψ-shaped long-wire antenna implemented as the GCPW wire on a substrate, according to a sixth embodiment of the present invention.

FIG. 12 illustrates a side view of the antennas according to the fourth to sixth embodiments of the present invention shown in FIGS. 9-11.

FIG. 13 illustrates a front view of a generalized ψ-shaped long-wire antenna implemented as the GCPW wire on a substrate, according to a seventh embodiment of the present invention.

FIG. 14 illustrates a front view of an antenna that the straight line shaped long-wire antenna implemented as the GCPW wire on a substrate is combined with any impedance matching circuits, according to an eighth embodiment of the present invention.

FIG. 15 illustrates a graph showing a characteristic reflection loss of the straight line shaped long-wire antenna implemented on the substrate.

FIG. 16 illustrates a graph showing a characteristic of reflection loss of the Y-shaped long-wire antenna implemented on the substrate.

FIG. 17 illustrates a graph showing a characteristic of reflection loss of the ψ-shaped long-wire antenna implemented on the substrate.

FIG. 18 illustrates an E-plane radiation pattern of the straight line shaped long-wire antenna implemented on the substrate.

FIG. 19 illustrates an H-plane radiation pattern of the straight line shaped long-wire antenna implemented on the substrate.

FIG. 20 illustrates an E-plane radiation pattern of the Y-shaped long-wire antenna implemented on the substrate.

FIG. 21 illustrates an H-plane radiation pattern of the Y-shaped long-wire antenna implemented on the substrate.

FIG. 22 illustrates an E-plane radiation pattern of the ψ-shaped long-wire antenna implemented on the substrate.

FIG. 23 illustrates an H-plane radiation pattern of the ψ-shaped long-wire antenna implemented on the substrate.

### DETAILED DESCRIPTION OF THE EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 shows a case in which a mobile communication terminal 10 wirelessly transmits a large amount of data to a display apparatus 20. The mobile communication terminal 10 may contain an embedded antenna (not shown) implemented on a substrate. The antenna may be an antenna having a horizontal radiation pattern. Therefore, in the transmission of a large amount of data, the antenna can have high transmission efficiency when the mobile communication terminal 10 lies horizontally at a level substantially the same as that of the display apparatus 20 as shown in FIG. 1.

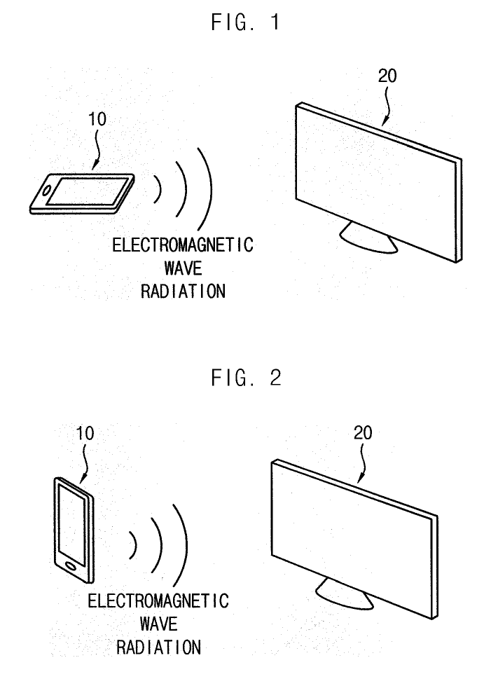

FIG. 2 shows a transmission mode using a vertical radiation pattern of the antenna (not shown) embedded in the mobile communication terminal 10. When the mobile communication terminal 10 is erected vertically, it can have the best transmission efficiency for the display apparatus 20 at a similar height.

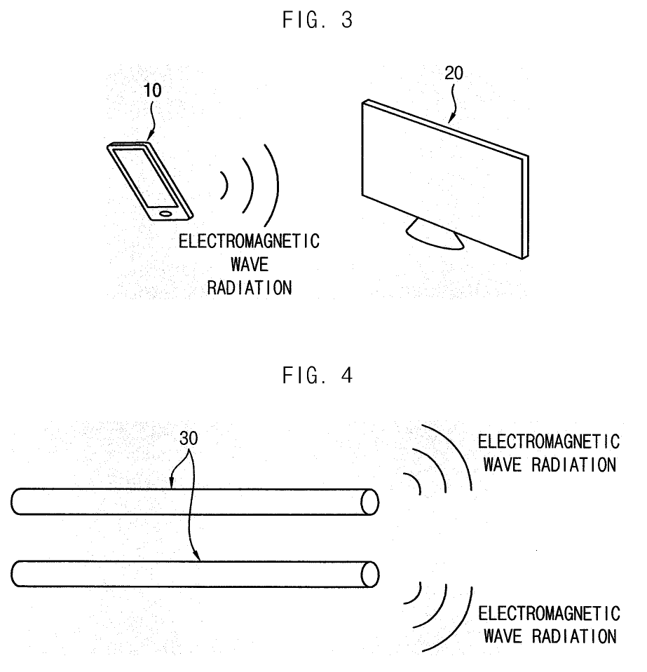

However, in the wireless communications using the millimeter waveband such as the mobile communication terminals, not only the communication way using the vertical or horizontal radiation pattern as above but also a communication way using a diagonal radiation pattern in an intermediate direction of these two may be also required. FIG. 3 illustrates a wireless transmission using a diagonal radiation pattern of an antenna embedded in the mobile communication terminal 10 for the large amount of data transmission. The present invention aims to provide an antenna having an excellent characteristic of the diagonal radiation pattern.

To this end, inventors of the present invention pay attentions to the radiation characteristics of the long-wire antenna. With an elongated conductive wire (for example, longer than one or more wavelength of an RF signal), it is possible to obtain a radiation pattern in the diagonal direction. That is, as shown in FIG. 4, a long-wire antenna 30 composed of two conductive wires elongated in parallel has a radiation characteristic of radiating the electromagnetic wave in a downward-diagonal direction and in an upward-diagonal direction with respect to the longitudinal direction of the conductive wires. Based on this respect, there is a need to develop an antenna structure having a diagonal radiation pattern that enables the antenna to be reduced in size, suitable for installation in a limited space, and easy to manufacture.

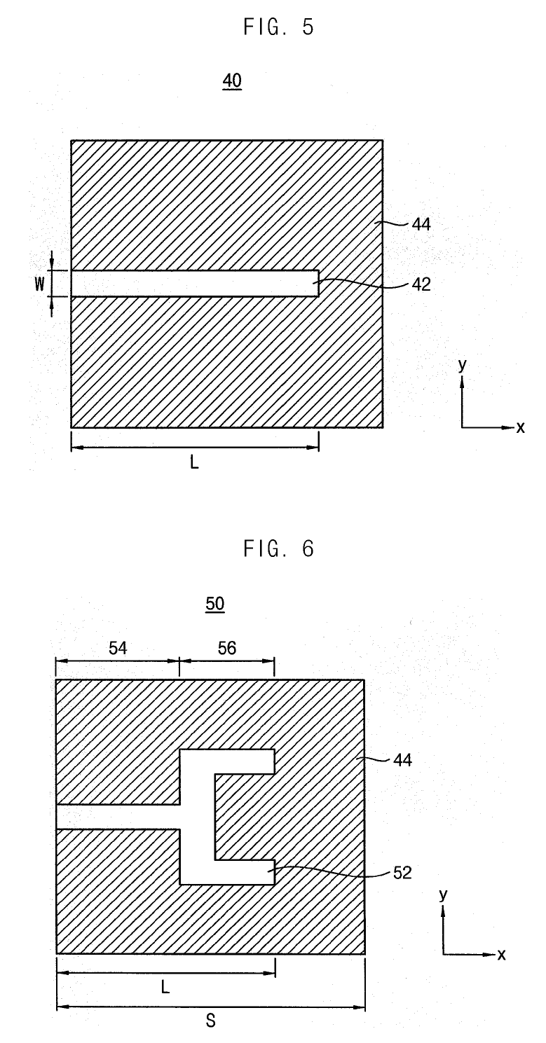

FIG. 5 illustrates a straight line shaped long-wire antenna 40 according to a first embodiment of the present invention. A side view of the antenna 40 is illustrated in FIG. 8. The long-wire antenna 40 may be constructed with a dielectric substrate 46 as the center portion thereof, and a lower metal layer and an upper metal layer both of which are attached to or coated on the bottom and top surfaces of the dielectric substrate 46, respectively. The lower metal layer may be provided as a ground electrode plate 44, and the upper metal layer may be a straight line shaped microstrip wire 42 provided as a signal feeding wire.

The dielectric substrate 46 may be, for example, a rectangular parallelepiped or a rectangular plate having a x-directional length S, preferably having a uniform thickness. The dielectric substrate 46 may be made of, for example, a substrate for the printed circuit board (PCB). The microstrip wire (42) is elongated in the x-direction from the midpoint of a first lateral edge of the dielectric substrate 46 toward an opposite edge of the first edge) by a predetermined length L. The microstrip wire 42 may be a straight band shape, and its length L and width W may be determined in consideration of the impedance matching.

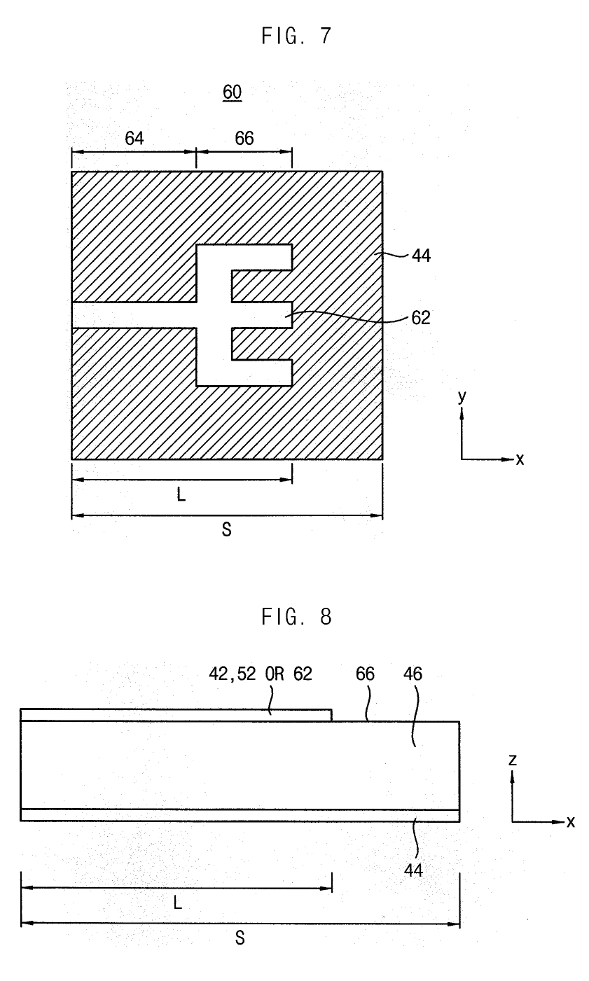

FIGS. 6 and 7 illustrate other antenna structures 50 and 60 according to the second and third embodiments of the present invention, respectively. These are the modified ones based on the straight line shaped long-wire antenna 40 according to the first embodiment, for improving the impedance matching characteristics.

In detail, FIG. 6 illustrates a front view of a Y-shaped long-wire antenna 50 as a modification of the straight line shaped long-wire antenna structure. The Y-shaped long-wire antenna 50 shares the same structural feature as the first embodiment in that the ground electrode plate 44 is attached to or coated on the bottom surface of the dielectric substrate 46, but has a difference in that the microstrip wire 52 on the top surface of the dielectric substrate 46 is not straight line shaped but Y-shaped.

FIG. 7 is a front view of a T-shaped long-wire antenna 60, modified by adding an additional branch wire to the Y-shaped antenna 50. The T-shaped long-wire antenna 60 is different from the long-wire antenna according to the first embodiment in that the microstrip wire 62 on the top surface of the dielectric substrate is T-shaped like a fork.

It is preferable for the microstrip wires 42, 52 and 62 to have a length L that is not less than a half-wavelength λ/2 of the RF signal to transmit. In the second and third embodiments of the present invention, the x-directional length of partial sections (referred to as ‘stem sections’) 54 and 64, including a signal-feeding point, of the microstrip wires 52 and 62 may be substantially equal to the x-directional length of the remaining sections (referred to as ‘branch sections’) 56 and 66, respectively. For example, when the total length L of the microstrip wires 52 and 62 is equal to one wavelength λ, the stem sections 54 and 64 and the branch sections 56 and 66 may have a half-wavelength λ/2.

With such configurations, the first to third long-wire antennas 40, 50, and 60 may have substantially the same radiation pattern. That is, when a signal to be transmitted wirelessly is fed into a position of x=0, or the feeding point, of the microstrip wires 42, 52, and 62, the antennas 40, 50, and 60 may show a radiation pattern that a RF signal corresponding to the fed signal is transmitted in a diagonal direction between the x-direction and the z-direction.

However, the first to third long-wire antennas 40, 50, and 60 have a difference therebetween in the impedance matching. For the straight line shaped long-wire antenna 40, the impedances of the first long-wire antenna 40 when viewed at any position among a point of x=0, a point of x=L/2, and a point of x=L may have the same value (for example, 200Ω). On the other hand, for the Y-shaped long-wire antenna 50, its stem section 54 may be the same as the corresponding section of the straight line shaped long-wire antenna 40, but its branch section 56, not being the same as the straight line shaped long-wire antenna 40, has two branches connected in parallel. Thus, the impedance of the Y-shaped long-wire antenna 50 when viewed at a starting point of the branch section 56 may be reduced to half of the corresponding impedance of the straight line shaped long-wire antenna 40. For example, as the branch section 56 may be the same as two branches of 200Ω connected in parallel, the impedance at a point of x=L/2 may be loon. The ψ-shaped long-wire antenna 60 may have much more branches compared to the Y-shaped long-wire antenna 50. Therefore, for the antenna impedance at the position of x=L/2, the ψ-shaped long-wire antenna 60 may have a smaller value than the Y-shaped long-wire antenna 50.

Although in the drawings it is illustrated that the ground electrode plate 44, a lower metal portion of the dielectric substrate 46, is coated on or attached to all over the bottom surface of the dielectric substrate 46, it is not necessarily needed for the ground electrode plate 44 to cover the entire bottom surface of the dielectric substrate 46. There may be no problem even though the ground electrode plate 44 covers a part of the bottom surface of the dielectric substrate 46.

Each of the microstrip wires 42, 52, and 62 on the top surface of the dielectric substrate 46 may be included within, in other words, may be covered by the ground electrode plate 44 when viewed in the z-direction in FIG. 8, that is, in a direction perpendicular to the top surface of the dielectric substrate. It is preferable that length L and width W of each of the microstrip wires 42, 52 and 62 may not be larger than those of the ground electrode plate 44, and they may be also positioned substantially along the center line of the ground electrode plate 44. That is, the length L of each of the microstrip wires 42, 52 and 62 may be shorter than the x-directional length S of the ground electrode plate 44 such that a part of the ground electrode plate 44 is not covered by each of the microstrip wires 42, 52 and 62. Due to these formations of the microstrip wires 42, 52 and 62 and the ground electrode plate 44, the electromagnetic wave radiated in the downward diagonal direction from each of the microstrip wires 42, 52 and 62 is incident on and reflected into the upward diagonal direction by the ground electrode plate 44. The reflected electromagnetic wave propagates in an upward diagonal direction together with a RF signal directly radiated from each of the microstrip wires 42, 52, and 62 in the upward diagonal direction.

According to the antenna structures 40, 50 and 60 as illustrated in FIGS. 5 to 7, the x-directional length L of each of the microstrip wires 42, 52 and 62 may be shorter than the x-directional length of the ground electrode plate 44. In this case, when the microstrip wires 42, 52 and 62 and the ground electrode plate 44 start from the same position in the x-direction, the dielectric substrate 46 may have a section 66 not covered by each of the microstrip wires 42, 52 and 62. This section 66 without the microstrip section may allow the electromagnetic wave reflected by the ground electrode plate 44 to be radiated much more in the upward diagonal direction between the x-direction and the z-direction.

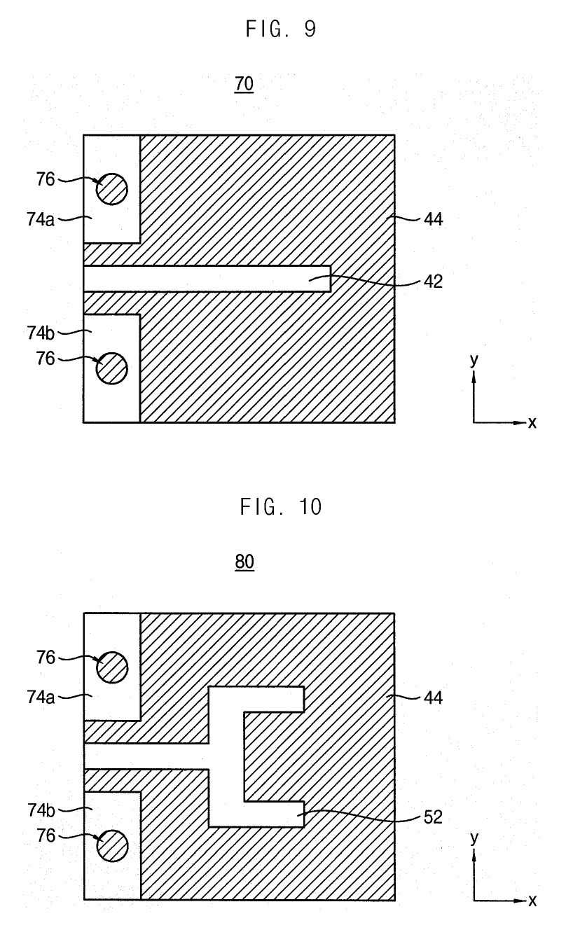

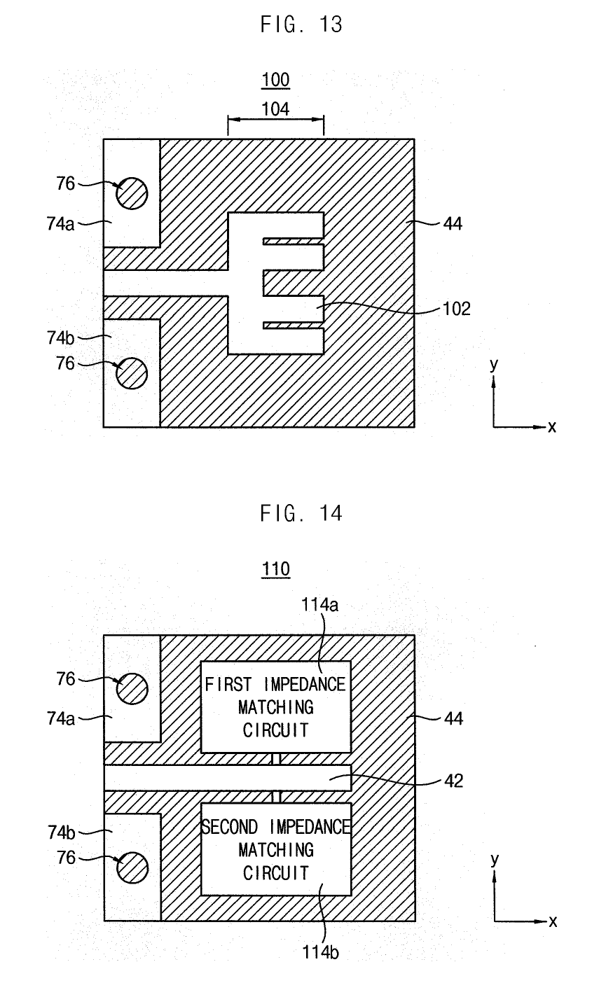

Next, FIGS. 9, 10 and 11 are front views of the long-wire antenna 70, 80 and 90 according to the fourth to sixth embodiments of the present invention, respectively. FIG. 12 is a side view of these long-wire antennas 70, 80 and 90. These three antennas 70, 80 and 90 are different from those of the first to third embodiments described above in that the upper metal portion provided on the top surface of the dielectric substrate 46 is built by the GCPW wire in place of the microstrip wire.

In detail, the antenna 70 according to the fourth embodiment illustrated in FIG. 9 may have a structure that a straight microstrip wire 42 is provided on the top surface of the dielectric substrate 46 like the first embodiment, and a pair of GCPW wires 74a and 74b may be further provided in a form of being attached to or coated on the left and/or right top surfaces of the dielectric substrate 46 about the microstrip wire 42, in other words, on the top surface of the dielectric substrate 46 in the right and/or left regions about the microstrip wire 42. Each of the GCPW wires 74a and 74b may include a pair of ground metal pads coated on the top surface of the dielectric substrate 46. In each of the pair of ground metal pads, may be formed a via hole 76 passing through vertically the dielectric substrate 46 and being extended to the ground electrode plate 44. Each of the ground metal pads 74a and 74b may be electrically connected to the ground electrode plate 44 through a connection wire 78 passing through the via hole 76. Therefore, when the ground electrode plate 44 is grounded, the GCPW wires 74a and 76b are also grounded. In connecting a chip to the antenna in the millimeter waveband, the GCPW wires 74a and 74b may be the element required for ensuring the connection between the chip and the antenna using, for example, a flip-chip bonding technique or a wire-bonding technique.

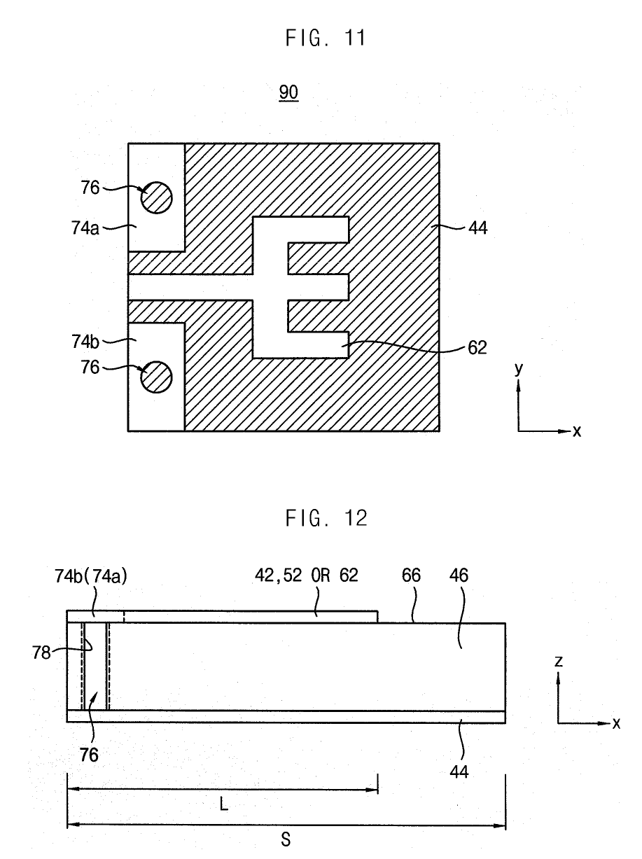

An antenna 80 according to the fifth embodiment, illustrated in FIG. 10, has a structure that the pair of GCPW wires 74a and 74b are further provided on the top surface of the dielectric substrate 46 in the left and right regions of the stem section 54 of the Y-shaped microstrip wire 52 of the antenna 50 according to the second embodiment illustrated in FIG. 6. An antenna 90 according to the sixth embodiment illustrated in FIG. 11 has also a structure that the pair of GCPW wires 74a and 74b are further provided on the top surface of the dielectric substrate 46 in both the left and right regions of the stem section 64 of the ψ-shaped microstrip wire 62 of the antenna 60 according to the third embodiment illustrated in FIG. 7. In these two antennas 80 and 90, the pair of GCPW wires 74a and 74b are electrically connected to the ground electrode plate 44 through the connection wire 78 passing through the via hole 76 like the antenna 70 according to the fourth embodiment.

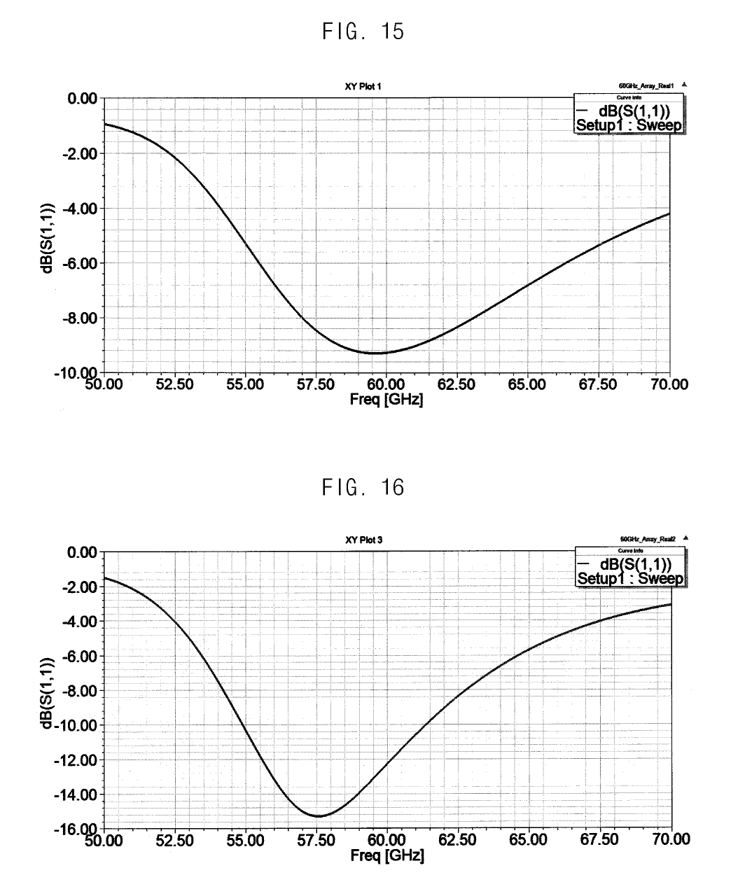

Based on the embodiments described above, it may be possible to derive modified antenna structures illustrated in FIGS. 13 and 14. The antenna 100 according to the seventh embodiment illustrated in FIG. 13, as a modification of the antenna 90 according to the sixth embodiment, has a structure having four or more branches in a branch section 104 of a microstrip wire 102. The impedance of the branch section 104 will be reduced as the number of branches in the branch section 104 of the microstrip wire 102 increases.

The antenna 110 according to the eighth embodiment illustrated in FIG. 14 has a structure that an impedance matching circuit is added to the antenna 70 according to the fourth embodiment illustrated in FIG. 9. According to the drawing, two impedance matching circuits 114a and 114b are additionally installed on the left and right of the straight microstrip wire 42, being electrically connected to the microstrip wire 42, but that is just an example. The number of the impedance matching circuit to be added may be just one, or three or more. In addition, there is no particular restriction on its shape and size if it is possible to obtain an impedance value required.

The antennas 40, 50, 60, 70, 80 and 90 in accordance with the several embodiments as described above can be made using a material that metal foils are coated on both sides of a plate-shaped dielectric substrate. For example, various types of metal wires 42, 52 and 62 on the top surface of the material may be formed by, for example, an etching process. In addition, the pair of GCPW pads 74a and 74b may be formed by the etching process, too.

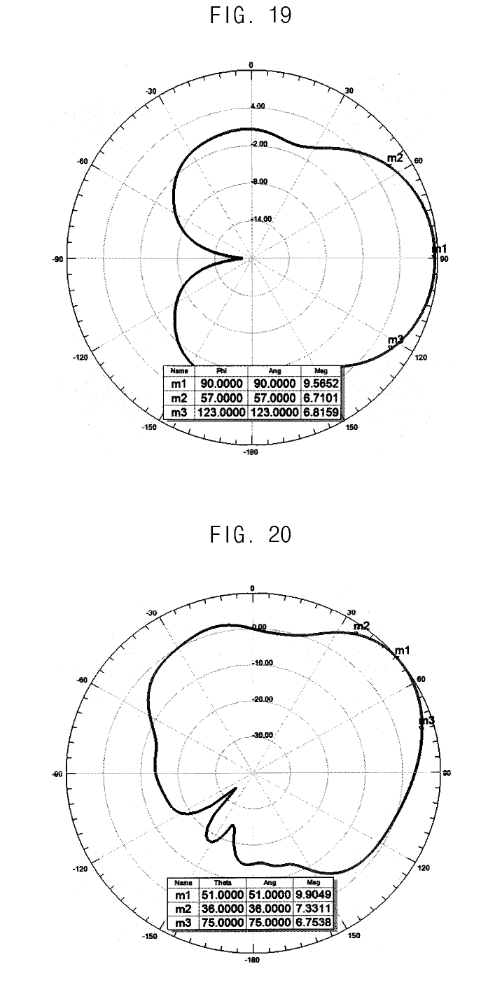

In the meantime, FIGS. 15, 16, and 17 show a reflection loss characteristic of the diagonal radiation antennas proposed by the present invention. FIGS. 18 to 23 illustrate an E-plane radiation pattern and an H-plane radiation pattern of the diagonal radiation antennas proposed by the present invention.

The graphs shown in FIGS. 15 to 23 are the results that were obtained and confirmed in a 3D electromagnetic (EM) simulation environment. To describe a possibility of implementation through the embodiments, the simulation results are incorporated here. In the simulations, as the dielectric substrate 46, used was a TLY-5 substrate of Taconic as an example under a condition that a dielectric constant and a loss tangent of it are 2.2 and 0.009, respectively. Copper (Cu) was used for the metal parts, that is, the ground electrode plate 44 and the microstrip wires 42, 52 and 62, attached to or coated on the top and bottom surfaces of the dielectric substrate 46. All of the straight line shaped long-wire antennas 40 and 70, the Y-shaped antennas 50 and 80, and the T-shaped antennas 60 and 90 were designed to have the same dimension of, for example, 2.5 mm×5 mm×0.38 mm in width×length×height.

Although the simulation results of the embodiments of the present invention were obtained using the properties of Taconic's dielectric substrate, but may be applicable to any other kinds of substrates having a property of planar substrate, such as PCBs, Duroid® substrates, alumina substrates, Taconic's substrates, ceramic substrates, low temperature co-fired ceramic (LTCC) substrates, etc.

FIG. 15 illustrates a reflection loss of the straight line shaped long-wire antennas 40 and 70 implemented on the dielectric substrate 46. According to this, the frequency characteristics of the straight line shaped long-wire antennas 40 and 70 do not go below −10 dB.

FIG. 16 illustrates a reflection loss of the Y-shaped long-wire antennas 50 and 80 implemented on the dielectric substrate 46. These antennas show a characteristic of reflection loss less than −10 dB in a frequency bandwidth of 6.5 GHz from 54.9 GHz to 61.4 GHz.

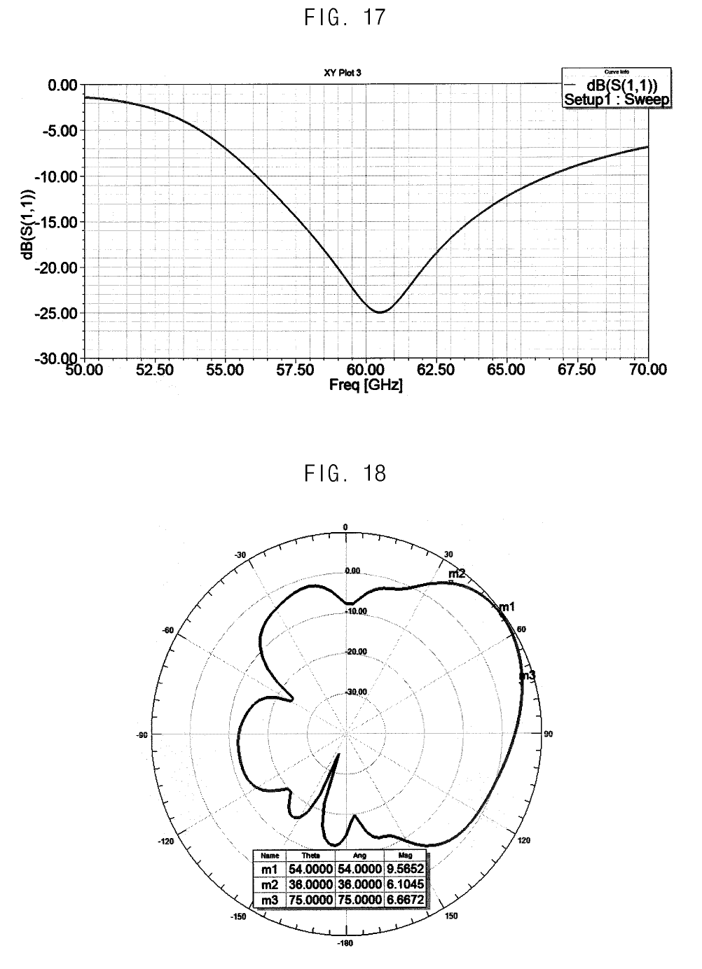

FIG. 17 illustrates a reflection loss of the T-shaped long-wire antennas 60 and 90 implemented on the dielectric substrate 46. These antennas show a characteristic of reflection loss less than −10 dB in a frequency bandwidth of 10.5 GHz from 56.1 GHz to 66.6 GHz.

Much more impedance matching elements may be added to the metal wires 42, 52, and 62 on the top surface of the dielectric substrate 46 as it goes in an order of the straight line shaped long-wire antennas 40 and 70, the Y-shaped long-wire antennas 50 and 80, and the T-shaped long-wire antennas 60 and 90. It can be assumed that due to such additional impedance matching elements, the characteristics of reflection loss may be further improved as it goes in the order of the straight line shaped long-wire antennas 40 and 70, the Y-shaped long-wire antennas 50 and 80, and the ψ-shaped long-wire antennas 60 and 90. The reflection loss characteristic graphs shown in FIGS. 15 to 17 can support that such an assumption is correct. That is, the additional impedance matching elements can secure a better impedance matching and thus can to contribute to improving the reflection loss characteristic of the antennas.

FIGS. 18 and 19 illustrate the radiation patterns in the E-plane and the H-plane of the straight line shaped long-wire antennas 40 and 70 implemented on the dielectric substrate, respectively. It can be seen from FIG. 18 that the 3-dB bandwidth in the E-plane is 39°, and it can be seen from FIG. 19 that the 3-dB bandwidth in the H-plane is 66° and the maximum gain of the antennas is 9.5 dBi.

FIGS. 20 and 21 illustrate the radiation patterns in the E-plane and the H-plane of the Y-shaped long-wire antennas 50 and 80 implemented on the dielectric substrate, respectively. It can be seen from FIG. 20 that the 3-dB bandwidth in the E-plane is 39°, and it can be seen from FIG. 21 that the 3-dB bandwidth in the H-plane is 72° and the maximum gain of the antennas is 9.9 dBi.

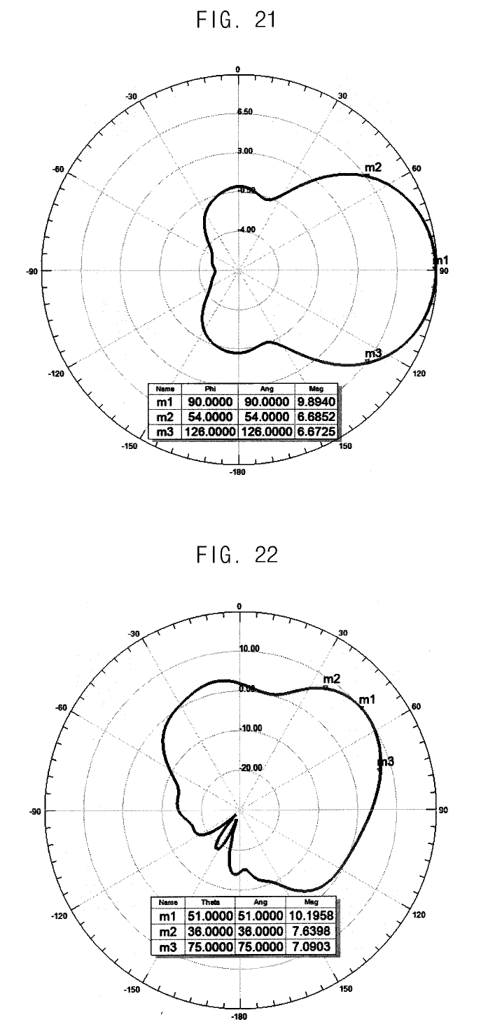

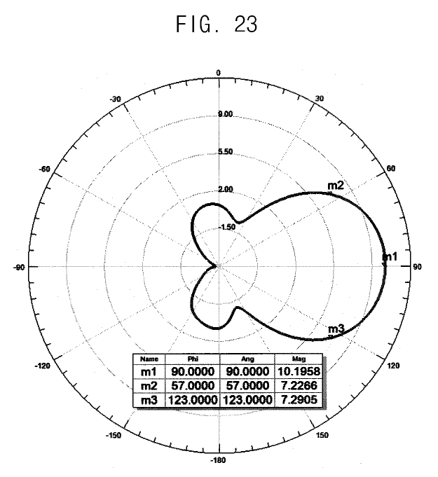

FIGS. 22 and 23 illustrate the radiation patterns in the E-plane and the H-plane of the ψ-shaped long-wire antennas 60 and 90 implemented on the dielectric substrate, respectively. It can be seen from FIG. 22 that the 3-dB bandwidth in the E-plane is 39°, and it can be seen from FIG. 23 that the 3-dB bandwidth in the H-plane is 66° and the maximum gain of the antennas is 10.2 dBi.

Through FIGS. 18 to 23, it can be confirmed that adding the impedance matching circuit can ensure the better impedance matching, which results in improvement of the antenna gain.

Example embodiments may be applicable to manufacturing a variety of millimeter-wave antennas.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present disclosure. Accordingly, all such modifications are intended to be included within the scope of the present disclosure as defined in the claims.

What is claimed is:

1. A long-wire antenna for millimeter wave radiation, the long-wire antenna comprising:
a dielectric substrate;
a first metal layer attached to or coated on at least a portion of a bottom surface of the dielectric substrate; and
a second metal layer attached to or coated on at least a portion of a top surface of the dielectric substrate in a form of microstrip wire,
wherein the first and the second metal layers are installed such that the second metal layer is covered by the first metal layer when the first and the second metal layers are viewed in a direction perpendicular to the top surface of the dielectric substrate,
the microstrip wire of the second metal layer has a length equal to or greater than a half of a wavelength of a radio frequency (RF) signal to be transmitted, and
the long-wire antenna has a RF signal radiation pattern in upward diagonal direction when a signal to be transmitted wirelessly is fed to the microstrip wire of the second metal layer when the first metal layer is grounded.

2. The long-wire antenna of claim 1, wherein the second microstrip wire is a straight line-shaped microstrip wire.

3. The long-wire antenna of claim 1, wherein the second microstrip wire is a Y-shaped microstrip wire including a first section that is a straight line shaped microstrip wire and a second section that is formed with two branches of the microstrip wire branched from an end of the straight line shaped microstrip wire.

4. The long-wire antenna of claim 3, wherein the first section and the second section of the Y-shaped microstrip wire have substantially a same length.

5. The long-wire antenna of claim 1, wherein the second microstrip wire is a ψ-shaped microstrip wire or a fork-shaped microstrip wire including a first section that is a straight line shaped microstrip wire and a second section that is formed with three or more branches of the microstrip wire branched from an end of the straight line shaped microstrip wire.

6. The long-wire antenna of claim 5, wherein the first section and the second section of the ψ-shaped microstrip wire or the fork-shaped microstrip wire have substantially a same length.

7. The long-wire antenna of claim 1, further comprising one or more grounded coplanar waveguide (GCPW) wires attached to or coated on the top surface of the dielectric substrate in a left region and/or a right region about the second metal layer.

8. The long-wire antenna of claim 7, wherein the GCPW wires comprise a pair of ground metal pads coated on the left and right top surfaces of the dielectric substrate about the second metal layer, wherein a pair of via-holes extended from each of the pair of ground metal pads to the first metal layer; and a pair of connection wires for electrically connecting each of the pair of ground metal pads to the first metal layer through the via-holes.

9. The long-wire antenna of claim 1, further comprising an impedance matching metal layer, attached to or coated on the top surface of the dielectric substrate and connected to the second metal layer, for improving impedance matching of the antenna.

10. The long-wire antenna of claim 1, wherein the second metal layer is shorter than the first metal layer in a lengthy direction of the second metal layer such that a section of the second metal layer uncovered by the first metal layer can be secured.

11. The long-wire antenna of claim 10, wherein a RF signal radiated from the second metal layer in a downward diagonal direction is incident on and reflected by the first metal layer, propagating in an upward diagonal direction with a RF signal directly radiated from the second metal layer in the upward diagonal direction.
